(19) United States
(12) Patent Application Publication
(10) Pub. No.: US 2015/0241280 A1
(43) Pub. Date: Aug. 27, 2015

(54) Folded Spatial Heterodyne Spectrometer

(71) Applicant: Matthias Lenzner, Tucson, AZ (US)

(72) Inventor: Matthias Lenzner, Tucson, AZ (US)

(21) Appl. No.: 14/631,376

(22) Filed: Feb. 25, 2015

Related U.S. Application Data
(60) Provisional application No. 61/944,884, filed on Feb. 26, 2014.

(51) Int. Cl. G01J 3/45; G01J 3/02; G01J 3/18

(52) U.S. Cl. CPC G01J 3/45; G01J 3/18; G01J 3/0208

(57) ABSTRACT

A technique and device to determine the spectrum of electromagnetic radiation in a certain range of wavelengths comprising: splitting said radiation into more than one beam; and imprinting a wavelength-dependent angular tilt onto the wavefront of each beam by two dispersive elements; and re-combining the multiple beams on a detector that exhibits spatial resolution and can therefore resolve the fringes formed by interference; and perform the mathematical operations to determine the spectrum of said radiation from the obtained interferogram, wherein the dispersive elements of one beam are mounted on a common stage providing linear and/or rotational movement

### CROSS-REFERENCE TO RELATED APPLICATION

This application claims the benefit of priority from U.S. Provisional Application No. 61/944,884, filed Feb. 26, 2014. The foregoing related application, in its entirety, is incorporated herein by reference.

### STATEMENT REGARDING FEDERALLY SPONSORED RESEARCH OF DEVELOPMENT

Not applicable

### BACKGROUND OF THE INVENTION

The current invention relates to optical spectrometers, especially interferometric optical spectrometers. More particularly, the invention is a method and a device to measure the modified or unmodified spectrum of a light source with high resolution.

Basically, there are two ways to get access to information about the spectral content of an electromagnetic wave in the optical range and the adjacent parts of the frequency spectrum, resulting in two kinds of optical spectrometer in existence.

One option is to spectrally disperse the incoming radiation by a dispersive element like a prism or a grating. The so obtained frequency-dependent intensity pattern can then be imaged onto a detector with spatial resolution (e.g. a CCD camera). If an appropriate relay imaging is involved, the complete spectrum within the bandwidth of the apparatus can be observed simultaneously. Usually, these spectrometers have an entrance slit; and the resolving power of the device increases with decreasing slit width. Consequently, the performance of such a device is a compromise between resolving power and detection threshold for low light intensity. A common embodiment of such a device is a Czerny-Turner spectrograph, comprising a rotatable plane grating between mirrors or lenses that image the entrance slit to the exit slit.

The second option is to use interference of the electric field of the radiation under test. For this, either a reference wave with known spectrum has to be used, or the radiation to be tested is split in two or more parts and an autocorrelation of the wave with itself is performed. The second way is usually preferred, since a reference source would severely limit the bandwidth or the operation range of the device. Commonly, the corresponding interferometric spectrometers are set up as Michelson or Mach-Zehnder interferometers. One of the two beams is temporally delayed with respect to the other and a variation of this delay yields a time-dependent interference pattern, which can be converted to a spectrum by way of Fourier transform. A common disadvantage of time-delay based Fourier-Transform Spectrometers (as opposed to dispersive spectrometers) is that all spectral components contribute noise to the measured signal. Fourier Transform Spectrometers and Fabry-Perot spectrometers are common embodiments of the interferometric kind, the latter one being an example for an input spectrum that is compared to a fixed reference spectrum (the transmission spectrum of the Fabry-Perot setup).

Another version of interferometric spectrometers are realized by generating Fizeau fringes, the spatial frequency of which contains information about the spectrum of the radiation under test. Here too, at least two beams are generated from the incoming light which are brought to interference under a defined angle. From the interferogram, the spectrum may again be obtained by way of a numerical Fourier transform. Differently from the Fourier transform spectrometers that use a temporal delay between the two interfering spectral functions, these spectrometers can collect the complete spectrum within the bandwidth of the device simultaneously without the need to move any parts.

A modern version of these Fizeau interferometers is the “spatial heterodyne spectrometer” (U.S. Pat. Nos. 5,059,027; 7,119,905; 7,330,267; 7,466,421; 7,773,229; and US Patent Applications with Publication Nos. 20050046858; 20090231592; 20100321688; 20130188181; 20140029004; 20150030503), where a reflective diffraction grating under Littrow angle causes the necessary wavefront tilt for close off-Littrow wavelengths. These spectrometers can be built compact and without moving parts, however, they generally require optical elements of high quality.

### BRIEF SUMMARY OF THE INVENTION

The invention is aimed at reducing the requirements for precise and synchronous operation of the moving mechanical parts of a Spatial Heterodyne Spectrometer (SHS) by folding the beam paths into a pattern that facilitates the mounting of the respective gratings onto a single rotational stage. With sufficiently precise initial calibration, both gratings will always stop at the same angle relative to the optical axis of the device, yielding interferograms that relate to the same Littrow angle for both arms.

### BRIEF DESCRIPTION OF THE SEVERAL VIEWS OF THE DRAWING

FIG. 1 shows a schematic of a spatial heterodyne spectrometer as known in the art.

FIG. 2 shows a schematic of a folded heterodyne spectrometer using two reflective diffraction gratings mounted on a common rotational stage.

FIG. 3 shows a schematic of a folded heterodyne spectrometer using two reflective diffraction gratings and two field-compensating prisms mounted on a common rotational stage.

FIG. 4 shows a representation of the wave- and energy fronts travelling along the arms of a spatial heterodyne spectrometer and serves to calculate the resolution of the device.

FIG. 5 shows the number of Fizeau fringes that can be observed for a single emission line at 424.42 nm with a FSHS setup with the four given grating constants g.

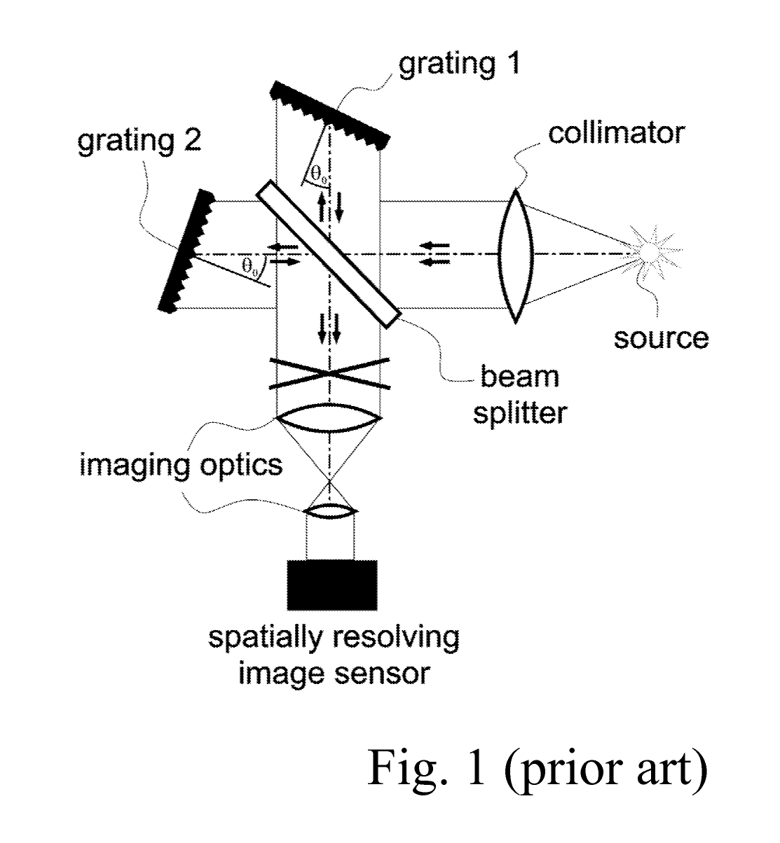

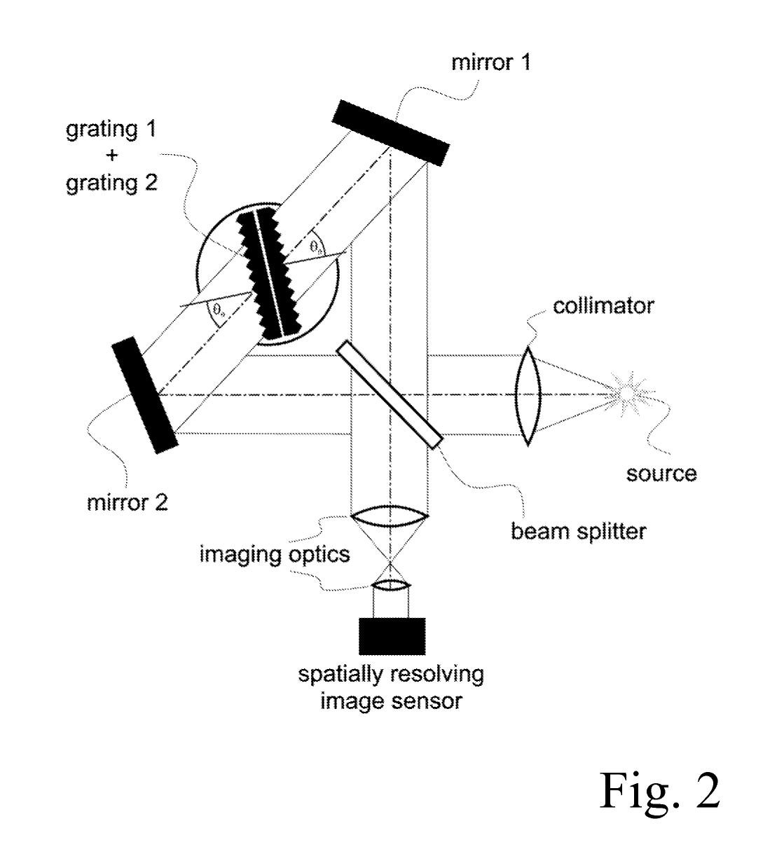

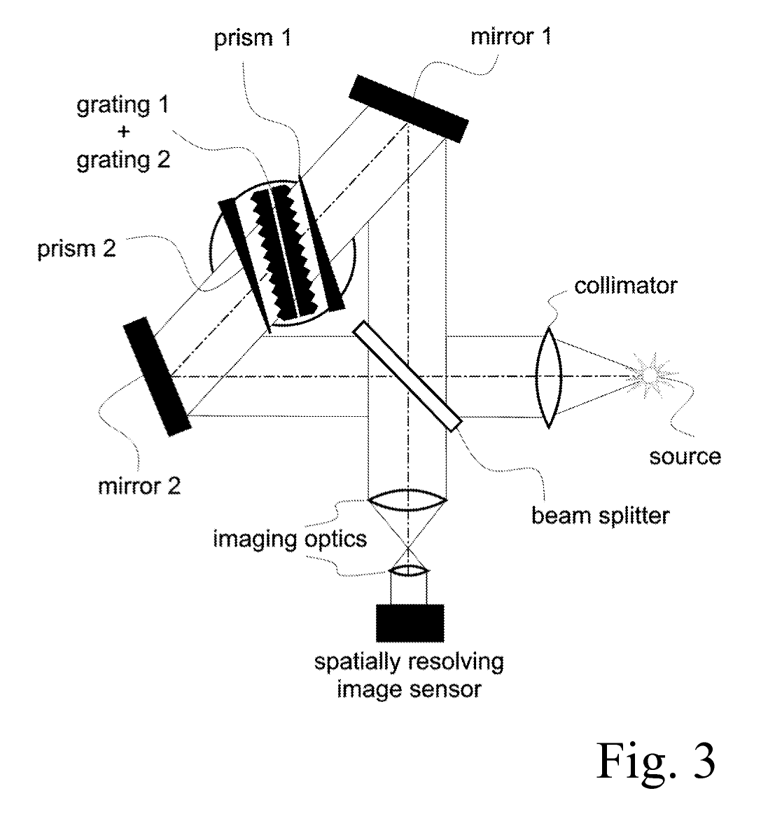

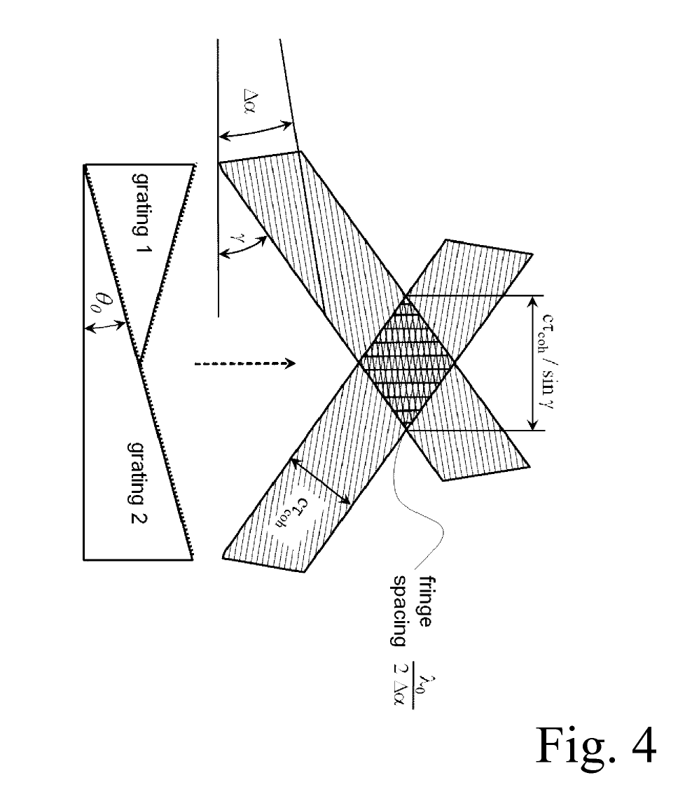

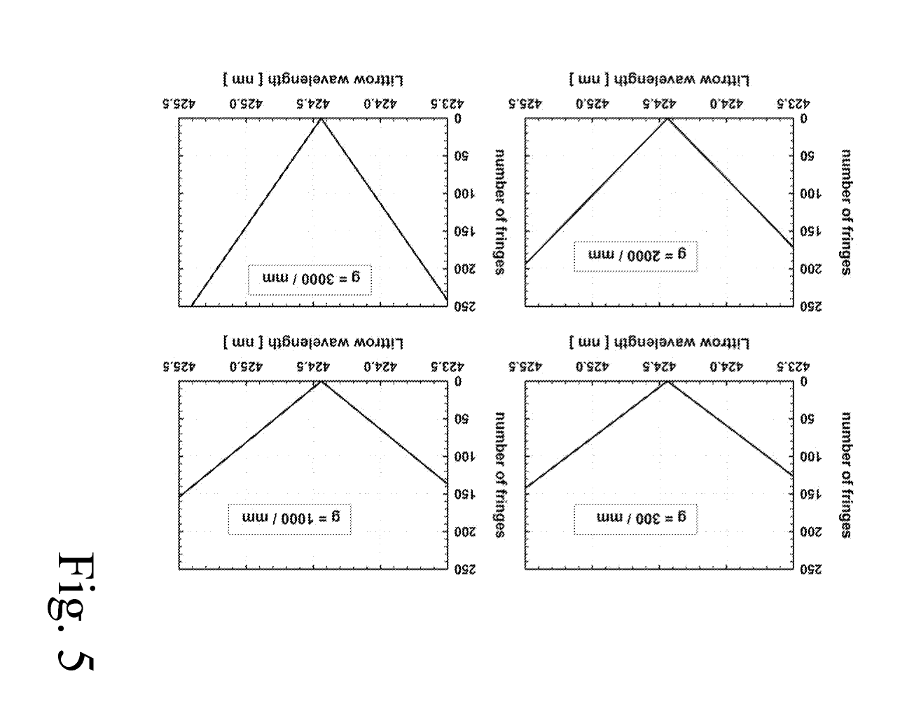

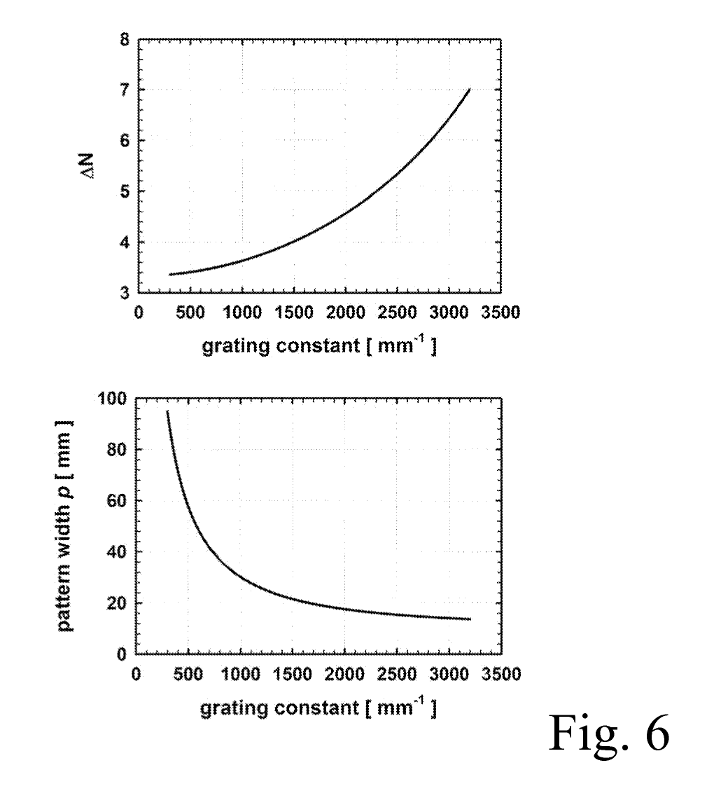

### DETAILED DESCRIPTION OF THE INVENTION

The Spatial Heterodyne Spectrometer (SHS) is basically a Michelson interferometer (see drawing 1—prior art), in which the mirrors are replaced by diffraction gratings with grating constant g (=groove density, =number of lines per unit length), corresponding to a groove distance of d=1/g. The gratings are placed under Littrow angle θ₀, defined by

$$sin {θ}_{0} = \frac{g {λ}_{0}}{2}$$

Light from the source under test, collimated by the collimator enters the SHS, is split into two parts by the beam splitter and travels along the two arms, as indicated by the arrows in drawing 1. It is then reflected by grating 1 and grating 2, recombined at the beam splitter and imaged by the imaging optics onto the spatially resolving image sensor. For the Littrow wavelength. the SHS acts (with some limitations that will be shown later) like a Michelson interferometer, yielding a bright field on the image sensor, when the arms have exactly equal lengths. For wavelengths close to the Littrow wavelength, the wavefronts entering the output arm are slightly tilted under opposite angles for the two arms (shown by the two black lines in drawing 1). Two tilted wavefronts of equal wavelength give rise to Fizeau fringes, which contain information about the spectrum of the source. This interferogram will be recorded by a spatially resolving image sensor (e.g. a CCD camera), a Fourier transform of this interferogram yields the spectrum of the source.

The achievable resolution of the SHS when the grating is used in first order amounts to [J. Harlander, R. J. Reynolds, F. L. Roesler, The Astrophysical Journal, vol. 396 (1992) page 730]:

$$R = \frac{4 W}{λ} sin {θ}_{0} ,$$

where W is the width of the illuminated region of the grating, so that

R=2Wg=2G,

where G is the total number of illuminated grooves. Consequently, the resolution of the SHS is equal to the standard resolution of a dispersive grating spectrometer but with both gratings combined.

The usable bandwidth of the SHS is limited by the highest fringe frequency that can be resolved by the detector. According to the Nyquist limit, with M pixels per unit length, on can resolve a spatial frequency of M/2. So, the bandwidth amounts to

$$M \text{/} 2 \cdot Δ λ = \frac{M λ}{2 R}$$

To extend the bandwidth of the device, the gratings can be rotated to a different angle, which shifts the Littrow wavelength of the setup. If this shift is chosen to be equal to the bandwidth of the device, a continuous wavelength coverage extending over a much larger range can be achieved. This larger resulting bandwidth is then limited by the nominal bandwidths of the optical components (especially the beam splitter), the grating constant of the utilized gratings (determining the Littrow angle) and the effective aperture in the two arms, caused by the tilt of the gratings. To facilitate an appropriate precision of the device, the rotation of the two gratings has to be precise and synchronous.

The Folded Spectral Heterodyne Spectrometer—as shown in drawing 2—modifies the beam path of a standard Michelson interferometer by folding the beam path of each arm once in order to redirect the optical axes to meet at a single location. Collimated light from the source enters the FSHS via the collimator and is split by the beam splitter into two beams. Then, both beams are redirected by mirror 1 and mirror 2 to hit grating 1 and grating 2 under an equal angle. The two gratings are placed on a common rotation stage, which allows simultaneous and absolutely synchronous rotation to extend the usable bandwidth range of the FSHS as described before. The light coming from the two optical paths is recombined at the beam splitter and the resulting interferogram is imaged by the imaging optics onto the spatially resolving image sensor.

To increase the etendue (area of the entrance pupil times the solid angle the source subtends as seen from the pupil) of the FSHS, field-compensating prisms can be employed as described for Fourier Transform Spectrometers [Ring, Schofield, Applied Optics vol. 11 (1972) page 507] and also employed for the prior-art SHS [J. Harlander, R. J. Reynolds, F. L. Roesler, The Astrophysical Journal, vol. 396 (1992) page 730]. These prisms have to be placed before each of the gratings, they are shown in drawing 3 as prism 1 and prism 2.

In drawing 4, the optical paths of the two arms are shown, projected onto a single optical axis, depicting the wavefront situation in the output arm of the SHS. For an incident wave packet with a center wavelength of λ₀+Δλ and a coherence time of τ_{coh}, the diffracted beam is deflected by a small angle Δα with respect to the incident direction. This angle is governed by the grating equation and amounts to

$$Δ α = \frac{Δ λ}{d cos {Θ}_{0}} = \frac{Δ λ}{d \sqrt{1 - \frac{{λ}_{0}^{2}}{4 {d}^{2}}}} ,$$

under the assumption that Δα is so small that cos Δα≈1 and sin Δα≈Δα. The wavefront is tilted (with respect to the incident wavefront) by this angle Δα as well, the energy front is tilted by a larger angle γ, given by

tan γ=2 tan Θ₀.

Both tilts are in opposite directions for the two gratings as shown in drawing 3. The long edges of the two large parallelograms depict the energy front while the parallel lines within these parallelograms depict the wavefront. From this, it becomes clear that there is a distinct difference between a Michelson interferometer with tilted mirrors and a FSHS with gratings under Littrow angle in that the field of observation of the Fizeau fringes is more limited for radiation with a short coherence length. From simple trigonometric relations in drawing 4, one can obtain the width of the interference pattern as projected onto the image sensor as cτ_{coh}/sin γ, and the spacing of the Fizeau fringes as λ₀/2 Δα. The number of fringes N within the width of the interference pattern can be obtained by dividing this width by the fringe spacing. The number of fringes that can be seen in the interference pattern of an emission line at wavelength λ₀+Δλ amounts to:

$$N = \frac{2 Δ λ}{Δ {λ}_{coh}} \sqrt{1 + 4 {tan}^{2} {Θ}_{0}}$$

where Δλ_{coh} is the coherent bandwidth of the wave packet which is equivalent to the coherence time of the at the specific wavelength Δλ_{coh}=λ₀²/cτ_{coh}.

The Littrow wavelength is included in the equation for N via the Littrow angle. Up to here, Δλ only denotes the position of one single emission line relativ to the Littrow angle that the FSHS is set to. The further away this line is from the Littrow wavelength (i.e. the larger Δλ), the more fringes one sees within the width of the interference pattern, which is otherwise constant for given Θ₀ and Δλ_{coh}. The FSHS has to be set to a Littrow wavelength that is slightly off the wavelength of the spectral features that have to be measured. Drawing 5 shows the total number of fringes for a single emission line at 424.42 nm in dependence on the angular setting of the SHS for four different grating constants.

### DETAILED DESCRIPTION OF AN EMBODIMENT OF THE INVENTION

A single practical embodiment of the FSHS would be a system designed to resolve the emission lines of the two ionized Uranium isotopes ²³⁵U and ²³⁸U at 424.437 nm with an isotope shift of λ₁−λ₂=0.025 nm and a linewidth of Δλ_{coh}=0.015 nm [W. Pietsch, A. Petit, A. Briand, Spectrochimca Acta Part B, vol. 53 (1998) page 751]. The interference pattern will consist of a beating of two sets of Fizeau fringes with two numbers of fringes that are different by ΔN, which is given by:

$$Δ N = \frac{2 ( {λ}_{1} - {λ}_{2} )}{Δ {λ}_{coh}} \sqrt{1 + 4 {tan}^{2} {Θ}_{0}}$$

This is a kind of resolution criterion, telling if two lines with given parameters can be resolved by the SHS. According to the Nyquist criterion, the period of the beat node has to be at least half the detector width to be resolved, i.e. ΔN≧2. The diagram in drawing 6 can be used to determine the grating constant of the two gratings utilized to achieve the necessary resolution and the interference pattern width p according to the size of the image sensor.

1. A folded spatial heterodyne spectrometer for determining the spectrum of incident light comprising:
means to split the incident light into a first optical path and a second optical path and direct it towards two mirrors;
wherein these two mirrors redirect the two beams towards two dispersive optical elements mounted on a single translation and/or rotation stage so that they can be moved simultaneously;
means to detect and record an spatially resolved image in one or two dimensions;
means to receive the spatially resolved intensity information from the image sensor and process it into a spectrum.

2. A folded spatial heterodyne spectrometer as in claim 1 wherein the dispersive devices are diffraction gratings.

3. A folded spatial heterodyne spectrometer as in claim 1 wherein the dispersive devices are single prisms of pairs of prisms.

4. A folded spatial heterodyne spectrometer as in claim 1 wherein the light source emits in the infrared part of the electromagnetic spectrum and the spectrometer is designed to process the infrared part of the spectrum.

5. A folded spatial heterodyne spectrometer as in claim 1 wherein the light source emits in the visible part of the electromagnetic spectrum and the spectrometer is designed to process the visible part of the spectrum.

6. A folded spatial heterodyne spectrometer as in claim 1 wherein the light source emits in the ultraviolet part of the electromagnetic spectrum and the spectrometer is designed to process the ultraviolet part of the spectrum.

7. A folded spatial heterodyne spectrometer as in claim 2 further comprising two field-compensating prisms positioned between the mirror and the grating in each of the optical paths.

8. A folded spatial heterodyne spectrometer as in claim 7 wherein the light source emits in the infrared part of the electromagnetic spectrum and the spectrometer is designed to process the infrared part of the spectrum.

9. A folded spatial heterodyne spectrometer as in claim 7 wherein the light source emits in the visible part of the electromagnetic spectrum and the spectrometer is designed to process the visible part of the spectrum.

10. A folded spatial heterodyne spectrometer as in claim 7 wherein the light source emits in the ultraviolet part of the electromagnetic spectrum and the spectrometer is designed to process the ultraviolet part of the spectrum.

11. A folded spatial heterodyne spectrometer as in claim 1 and in claim 7 used to distinguish the isotopic shift of emission lines in atoms and molecules.
